(19) United States
(12) Patent Application Publication
(10) Pub. No.: US 2026/0094220 A1
(43) Pub. Date: Apr. 2, 2026

(54) Automated Tool For Determining And Using User-Specific Predicted Attributes Of Dwellings That Users Will Later Occupy

(71) Applicant: MFTB Holdco, Inc., Seattle, WA (US)

(72) Inventors: Sai Wing Yeung, Everett, WA (US); Jack Gibbons, San Diego, CA (US); Prince Jain, Garden Grove, CA (US); Kai Liu, Lynnwood, WA (US); Nitish Jain, Fremont, CA (US)

(21) Appl. No.: 18/642,246

(22) Filed: Apr. 22, 2024

Related U.S. Application Data
(60) Provisional application No. 63/562,646, filed on Mar. 7, 2024.

(51) Int. Cl. G06Q 50/16; G06N 5/022; G06N 20/20

(52) U.S. Cl. CPC G06Q 50/16; G06N 5/022; G06N 20/20

(57) ABSTRACT

Techniques are described for performing automated operations related to determining and using information about one or more user-specific predicted attributes of dwellings that users will occupy in the future. The described techniques may include generating one or more predictive models trained to provide information about one or more target dwelling attributes of interest, such as to analyze training data about interactions of one or more types by a plurality of users with a plurality of dwellings before those users select a final dwelling to acquire and/or occupy, and to generate and train the predictive model(s) based on the training data to predict a value of each of the one or more target dwelling attributes for a target dwelling that a user will later acquire and/or occupy, and may further include using predicted target dwelling attribute values to provide dwelling-related information to one or more other users.

### CROSS REFERENCE TO RELATED APPLICATIONS

This application claims the benefit of U.S. Provisional Patent Application No. 63/562,646, filed Mar. 7, 2024 and entitled “Automated Tool For Determining And Using User-Specific Predicted Attributes Of Dwellings That Users Will Later Occupy,” which is hereby incorporated by reference in its entirety.

### TECHNICAL FIELD

The following disclosure relates generally to techniques for automatically determining and using information about one or more user-specific predicted attributes of dwellings that users will occupy in the future, such as to, before a user has selected a dwelling for occupancy, automatically determine and provide more accurate information to the user about that dwelling by using one or more predicted dwelling attributes for that dwelling that are based at least in part on prior interactions of the user with other dwellings.

### BACKGROUND

An abundance of information is available to users on a wide variety of topics from a variety of sources. For example, portions of the World Wide Web (“the Web”) are akin to an electronic library of documents and other data resources distributed over the Internet, with billions of documents available, including groups of documents directed to various specific topic areas (e.g., buildings of various types). In addition, various other information is available via other communication mediums. However, existing search engines and other techniques for identifying information of interest suffer from various problems. Non-exclusive examples include a difficulty in understanding natural language requests, difficulty in providing accurate information that is specific to a particular topic of interest and/or useful to a particular user, difficulty in limiting information requests to approved topics, etc.

### BRIEF DESCRIPTION OF THE DRAWINGS

FIGS. 1A-1B are network diagrams illustrating an example system for performing described techniques, including automatically determining and providing dwelling-related information to a user based on one or more user-specific predicted dwelling attributes of a dwelling that the user will eventually occupy.

FIGS. 2A-2E illustrate examples of performing described techniques, including automatically determining and providing dwelling-related information to a user based on one or more user-specific predicted dwelling attributes of a dwelling that the user will eventually occupy.

FIG. 3 is a block diagram illustrating an example of a computing system for use in performing described techniques, including automatically determining and providing dwelling-related information to a user based on one or more user-specific predicted dwelling attributes of a dwelling that the user will eventually occupy.

FIG. 4 illustrates a flow diagram of an example embodiment of an Automated Personalized Dwelling Attribute Information Provider (“APDAIP”) system routine.

FIG. 5 illustrates a flow diagram of an example embodiment of an APDAIP User/Dwelling Attribute Association Predictor component routine.

FIG. 6 illustrates a flow diagram of an example embodiment of a client device routine.

### DETAILED DESCRIPTION

The present disclosure describes techniques for using computing devices to perform automated operations involving automatically determining and using information about one or more user-specific predicted attributes of dwellings that users will occupy in the future, such as in at least some embodiments to, before a user has selected a dwelling (e.g., house, home, apartment, condominium, short-term rental, other building, etc.) for occupancy, automatically determine and provide more accurate and relevant information to the user about that dwelling by using one or more predicted dwelling attribute values for that dwelling that are based at least in part on prior interactions of the user with other dwellings. In at least some embodiments, the described techniques include generating one or more predictive models trained to provide information about one or more target dwelling attributes of interest, such as to analyze training data about interactions of one or more types by a plurality of users with a plurality of dwellings before those users select a final dwelling to acquire and/or occupy, and to generate and train the predictive model(s) based on the training data to predict a value of each of the one or more target dwelling attributes for a target dwelling that a user will later acquire and/or occupy—the generation and training of the predictive model(s) may be performed in various manners, as discussed further below. After the generation of the one or more trained predictive models, the trained predictive model(s) may be further used to automatically assist particular users in obtaining information about target dwellings that the users are predicted to eventually acquire and/or occupy, such as to generate and provide information to a user about a collection of multiple dwellings each having at least one predicted value for at least one target attribute that is determined for that user from the generated predictive model(s), to generate and provide information to a user as auto-complete suggestions for a partial dwelling-related query from the user that are each based on at least one predicted value for at least one target attribute that is determined for that user from the generated predictive model(s), to generate and provide information to a user about multiple buildings (e.g., search results matching one or more user-specified criteria) that are ranked and/or filtered based on at least one predicted value for at least one target attribute that is determined for that user from the generated predictive model(s), etc.—the use of the trained predictive model(s) may be performed in various manners, as discussed further below. Additional details are included below regarding automatically determining and using information about one or more user-specific predicted target dwelling attribute values that users will occupy in the future, and some or all of the techniques described herein may, in at least some embodiments, be performed via automated operations of an Automated Personalized Dwelling Attribute Information Provider (“APDAIP”) system, as discussed further below.

As noted above, the automated operations of the APDAIP system in at least some embodiments include generating one or more predictive models trained to provide information about one or more target dwelling attributes of interest using training data from numerous users' interactions with dwellings before selecting final dwellings to acquire and/or occupy. In at least some embodiments, for each of one or more target attributes of interest, a quantile random forest predictive model is generated and trained for a specific target attribute, with the quantile random forest model including numerous decision trees whose leaf nodes include values for that target attribute for the final dwellings that the numerous users have selected to acquire and/or occupy, and with the decision trees corresponding to random samples of the overall training data and having varying branches between their root and leaf nodes based on values of various attributes of other dwellings that the users for those random samples interacted with before selecting their respective final dwellings to acquire and/or occupy—in this manner, the leaf nodes provide a full distribution of values for the specific target attribute across various combinations of other attributes and values of previously interacted-with dwellings, and may be used to produce a predicted mean value for the specific target attribute in light of a specific group of dwellings and their associated attribute values interacted with by a particular new user, as well as predicted values for multiple other defined quantiles for the specific target attribute in light of the specific group of dwellings (e.g., for some or all single percentages, or percentiles, such as 1%, 2%, 3%, etc.; some or all multiples of 5 percentages, such as 5%, 10%, 15%, etc.; some or all multiples of 10 percentages, such as 10%, 20%, 30%, etc.; some or all quarter percentages, or quartiles, such as 25% and 75%; etc.). In at least some embodiments, such a quantile random forest predictive model is further generated and trained to provide at least one confidence value for one or more predicted values for the specific target attribute in light of a specific group of dwellings (e.g., multiple predicted values for multiple quantiles), such as to reflect variance in the full distribution for the specific target attribute in light of the specific group of dwellings based on the training data. Other predictive model types may be used In other embodiments, whether in addition to or instead of quantile random forest models, such as other random forest models, gradient boosting models (e.g., using a quantile loss function to generate quantile predictions), clustering models, neural network models, linear regression models, etc. Also, in addition to generating a predictive model for each of one or more target dwelling attributes, multiple predictive models may be generated and used for a given target dwelling attribute in some embodiments, such as to segment each such predictive model by geographical region and/or one or more user characteristics (e.g., gender, age, etc.) as permitted by applicable laws and regulations.

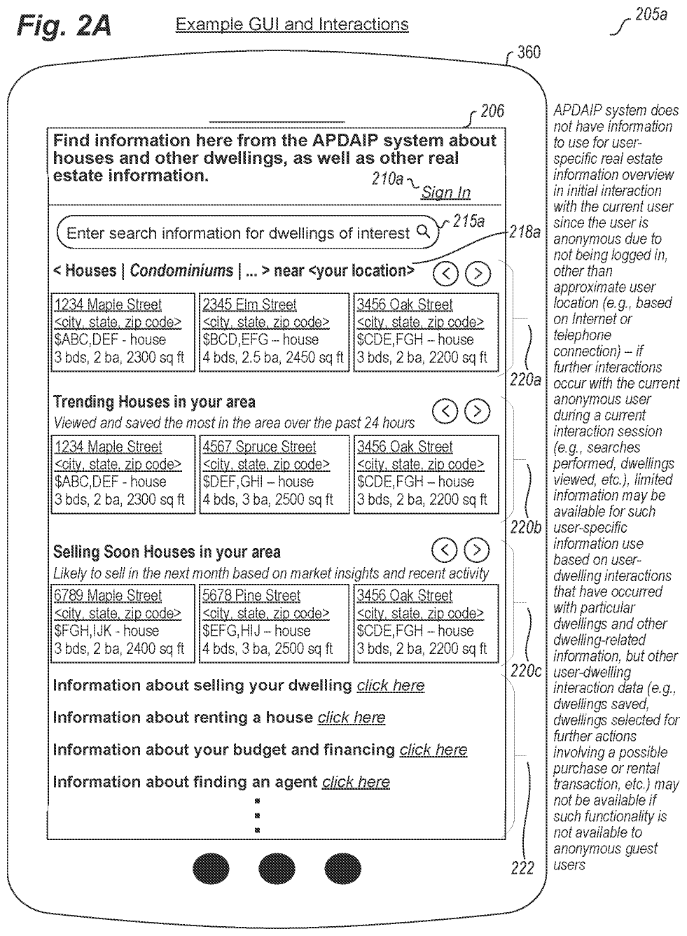

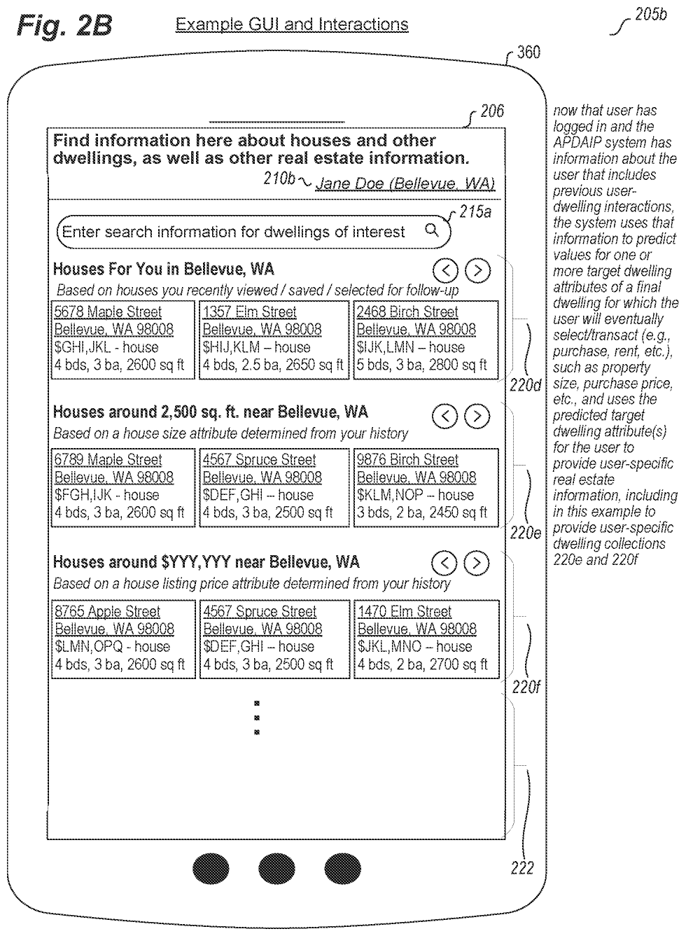

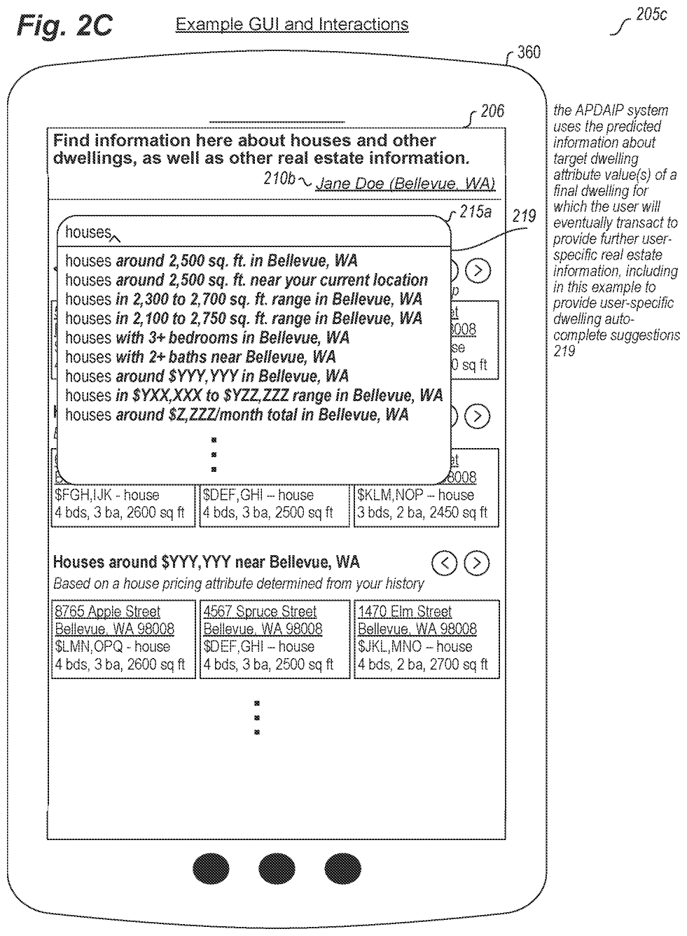

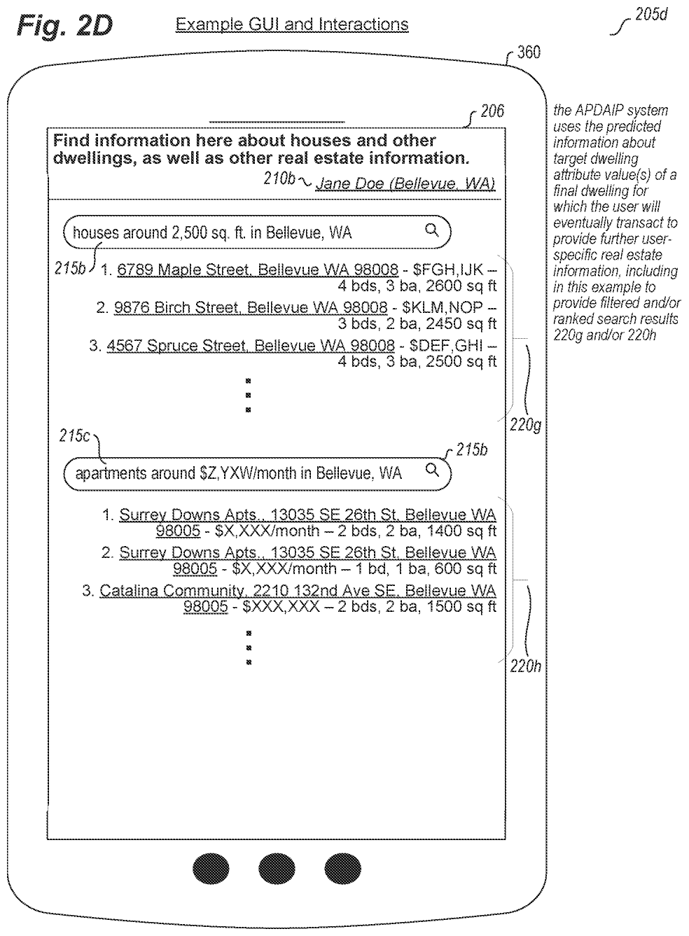

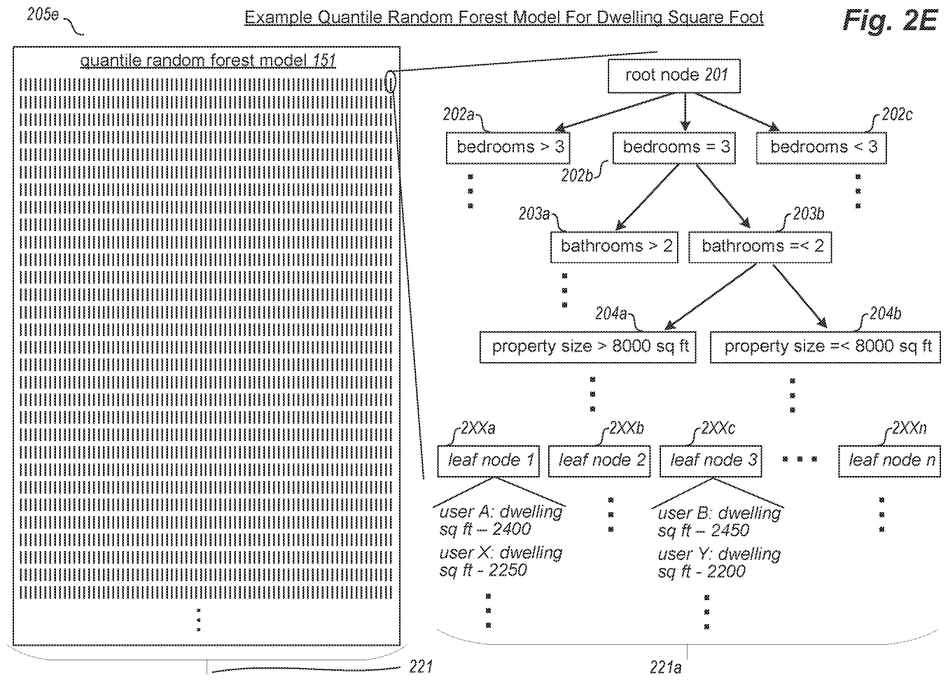

As noted above, the training data for use with a predictive model may include, for each of numerous users, information about a final dwelling selected by the user to acquire and/or occupy, as well as multiple other dwellings that the user interacted with before selecting the final dwelling. Such interactions may be of various types in various embodiments, including viewing online information about the other dwellings, saving or adding the other dwellings to an online list or group for later review, selecting the other dwellings for further interaction (e.g., visiting in person), etc., as well as the one or more interactions involved in selecting a final dwelling to acquire and/or occupy and optionally performing a transaction to complete the acquisition and/or occupation. The other dwellings and final dwelling for a user may also have a variety of attributes used for the generating and training, such as any quantifiable information about the dwellings (e.g., quantity of bedrooms, quantity of bathrooms, square footage of the dwelling, square footage of the property on which the dwelling is located, quantity of garage spaces, quantity of parking spaces, school district, HOA fees, listing price, purchase price, price per dwelling square foot, pool or not, water view or not, etc.), including information that is included in an MLS (multiple listing service) listing, as well as additional information that is derivable from other quantifiable information (e.g., distance to one or more specified types of services or amenities, such as a hospital, grocery store, park, etc.; estimated total monthly payments to finance a purchase with a specified down payment, such as to include a mortgage for the listing or purchase price along with estimates of other fees such as taxes, insurance, HOA fees, etc.; estimated total monthly payments to rent, such as to include estimates of other fees such as utilities and insurance; etc.). The one or more target dwelling attributes may be selected from such attributes in at least some embodiments based on having outsized effects on selection decisions for final dwellings, such as one or more of the following non-exclusive list: quantity of bedrooms, quantity of bathrooms, square footage of the dwelling, square footage of the dwelling's property, listing price, purchase price, etc. Additional details are included below related to generating one or more predictive models trained to provide information about one or more target dwelling attributes of interest using training data from numerous users' interactions with dwellings before selecting final dwellings to acquire and/or occupy, including with respect to the non-exclusive examples of FIGS. 2A-2E.

As is also noted above, the automated operations of the APDAIP system in at least some embodiments include using one or more trained predictive models to automatically assist particular users in obtaining information about predicted target dwellings that the users will eventually acquire and/or occupy. In at least some embodiments, the use of the one or more trained predictive models may occur while a user is interacting with a site or system that provides information about dwellings and optionally other types of real estate-related information, such as a site or system provided by the APDAIP system or using the APDAIP system. The interactions with the site or system may include registering a user and then tracking activities of the user with the site or system, including interactions of the user with various dwellings, and may further obtain and use various other additional information about the user (e.g., demographic information, preferences, etc.). In at least some embodiments, a user may interact with the site or system without being a registered user or otherwise having a known identity, such as to be a guest user—if so, the site or system may still track interactions with the guest user during a current interaction session, and in some cases across multiple interaction sessions if a unique identifier is associated with the user or the user's client device, but may not have access to other additional information about the guest user. If a user (whether registered or a guest) has previously interacted with a minimum quantity of dwellings (e.g., one, five, ten, fifty, one hundred, two hundred, etc.) for which the site or system has interaction data, such as over a defined prior period of time (e.g., a week, a month, etc.) or instead for the most recent group of dwellings up to a maximum quantity (e.g., ten, fifty, one hundred, two hundred, five hundred, etc.) over any prior period of time, the APDAIP system may use information about a group of such dwellings from a user's prior interactions to predict one or more values for each of one or more target dwelling attributes, and to provide user-specific functionality and information to that user based on the predicted target dwelling attribute value(s). In at least some embodiments and situations, the APDAIP system generates a range of predicted values for each target dwelling attribute, such as using a predicted lower bound of the range corresponding to a first selected quantile (e.g., 5%, 15%, 25%, 35%, etc.) and a predicted upper bound of the range corresponding to a second selected quantile (e.g., 60%, 70%, 80%, 90%, 95%, etc.)—in other embodiments and situations, the APDAIP system may use a single value for some or all target dwelling attributes, such as a predicted mean or 50% quantile value, or other value.

As one non-exclusive example, a user may interact with the site or system to request overview information about one or more types of real estate-related information, such as a request to load a home page for a Web site (e.g., by entering a URL corresponding to the Web site)—if so, the predicted value(s) for each of one or more target dwelling attributes from the APDAIP system may be used to generate user-specific information to add to the home page or other group of overview information provided to the user, such as to generate and provide information to a user about one or more collections of multiple dwellings, with each collection having at least one predicted value for at least one target attribute that is determined for that user and corresponding to one or more dwellings each having a value for the at least one target attribute that matches the collection's at least one predicted value (e.g., is within a range of the predicted values). The initially provided information for a collection in the overview information may be, for example, a user-selectable control that the user may select to obtain further information of an indicated type, such as a user-selectable button labeled with an associated type of dwelling information (e.g., “houses with 3 bedrooms”, “houses with 3 bedrooms in Seattle”, “houses with 3 or more bedrooms”, “houses around 2500 sq ft”, “houses between 2200 and 2600 sq ft”, “houses with 3 or more bedrooms and 2 or more bathrooms”, “houses around $300,000”, etc.), or may instead include actual details about one or more such dwellings in the overview information. As another non-exclusive example, a user may interact with the site or system to begin entering a query for information about dwellings, and the predicted value(s) for each of one or more target dwelling attributes from the APDAIP system may be used to generate user-specific information to provide one or more auto-complete suggestions for the partial dwelling-related query—for example, if the partial query was “houses in Seattle”, the auto-complete suggestions may include adding one or more possible criteria based on the predicted target dwelling attribute value(s) (e.g., “with 3 bedrooms”, “with 3 or more bedrooms”, “around 2500 sq ft”, “between 2200 and 2600 sq ft”, “with 3 or more bedrooms and 2 or more bathrooms”, “around $300,000”, etc.), and if the user selects one of the auto-complete suggestions, the system may then provide details about dwellings corresponding to the user-specified criteria. As yet another non-exclusive example, a user may interact with the site or system to enter a complete query for information about dwellings that includes one or more specified criteria, and the system may then provide dwelling-related information matching the user-specified criteria, with the predicted value(s) for each of one or more target dwelling attributes from the APDAIP system used to rank and/or filter the dwellings matching the user-specified criteria that are provided to the user (e.g., as search results)—for example, if the complete query was “houses in Seattle with a backyard”, the filtering and/or ranking may be used to improve the ranking of dwellings matching the user-specified criteria and also having predicted value(s) for each of one or more target dwelling attributes such as “3 bedrooms”, “3 or more bedrooms”, “around 2500 sq ft”, “between 2200 and 2600 sq ft”, “3 or more bedrooms and 2 or more bathrooms”, “around $300,000”, etc.), or alternatively to remove dwellings matching the user-specified criteria that do not match the predicted target dwelling attribute value(s). The predicted value(s) for each of one or more target dwelling attributes from the APDAIP system may be further used to generate user-specific information for a user in other manners in other embodiments, such as to determine and provide indications of multiple building collections corresponding to different predicted target dwelling attribute values at times other than with overview information (e.g., along with search results, such as to enable selection of subsets of the search results corresponding to a particular collection), to proactively push information to the user (e.g., recommendations via text or email), etc. Additional details are included below related to using trained predictive models to automatically assist particular users in obtaining information about predicted target dwellings that the users will eventually acquire and/or occupy, including with respect to the non-exclusive examples of FIGS. 2A-2E.

In at least some embodiments, some or all user queries may be entered using multiple free-form natural language terms to specify one or more search criteria, and if so the APDAIP system may analyze such a query to determine the user-specified criteria to use, including by segmenting the terms in the received query into one or more segments each corresponding to an indicated search criterion. Such segmenting of the sequence of term(s) may be performed in various manners in various embodiments, such as by identifying matches in one or more dictionaries (e.g., general-purpose dictionaries, dictionaries of POI location names, dictionaries of geographical area names, etc.) or other lists of word/phrase breaks, by considering each combination of singleton terms and two or more adjacent terms to determine if they match POI locations or geographical areas (e.g., for a sequence of terms such as “Space Needle Seattle”, considering alternative name-based designations of “Space”, “Needle”, “Seattle”, “Space Needle”, “Needle Seattle”, and “Space Needle Seattle”, and concluding that “Space” is grouped with “Needle” to identify a POI location name, leaving the name-based designation of “Seattle” to identify a surrounding geographical area that together uniquely identify the POI location, such as to differentiate the Space Needle in Seattle from other space needles in other geographical areas), etc. In some embodiments, each combination of terms is treated as a separate segment (e.g., for a sequence of terms such as “Stamford New York”, using all of “Stamford”, “New”, “York”, “Stamford New”, “New York” and “Stamford New York” as separate segments), or search queries may be parsed without using such segments. In addition, in some embodiments and situations, the received query may include one or more segments for one or more search criteria of one or more specific types, such as one or more of the following: dwelling-type designations (e.g., ‘apartment’, ‘single family house’, ‘condominium’, etc.); POI categories (e.g., “beaches”, “parks”, “schools”, “hospitals”, “lakes”, etc.); indeterminate distance indications that are associated with one or more POI locations and/or POI categories (e.g., “nearby” or analogous terms such as “near”, “by”, “around”, “at”, “close to”, “adjacent”, etc.; a travel-based distance measure with an indicated travel type, such as walking or bicycling or scootering or driving or bus or train or light rail or mass transit; etc., and an associated amount of travel time that is specified or otherwise determined); non-location-related search filters or other search criteria, such as search criteria related to dwelling attributes (e.g., minimum and/or maximum and/or target price, number of bathrooms, number of bedrooms, etc.), etc. In some embodiments and situations, a received query may include only an indication of a POI location or a POI category, and other search criteria such as geographical area and/or dwelling type and/or indeterminate distance and/or other dwelling-related attributes may be automatically determined for use with the search query (e.g., inferred, selected as a default, etc.), optionally based on information specific to a user who submitted the search query and/or a current context (e.g., as part of an ongoing search interaction session by using previously specified details). Additional details are included herein related to analyzing a sequence of one or more terms of a received query that is specified using free-form natural language.

The described automated techniques provide various benefits in various embodiments, including to significantly improve the identification and use of responsive information to specified queries for information about dwellings based at least in part on predicted values for one or more target dwelling attributes of final dwellings that user will select to acquire and/or occupy, including queries specified in a natural language format. Such automated techniques also allow such responsive answer information to be generated much more quickly and efficiently than previously existing techniques (e.g., using less storage and/or memory and/or computing cycles) and with greater accuracy, based at least in part on using the described techniques for improving the accuracy and relevance of information provided to users in user-specific manners, etc. In addition, in some embodiments the described techniques may be used to provide an improved GUI (graphical user interface) in which a user may more accurately and quickly obtain real estate-related information, including in response to an explicit request (e.g., in the form of a natural language query), as part of providing personalized information to the user, etc. Various other benefits are also provided by the described techniques, some of which are further described elsewhere herein.

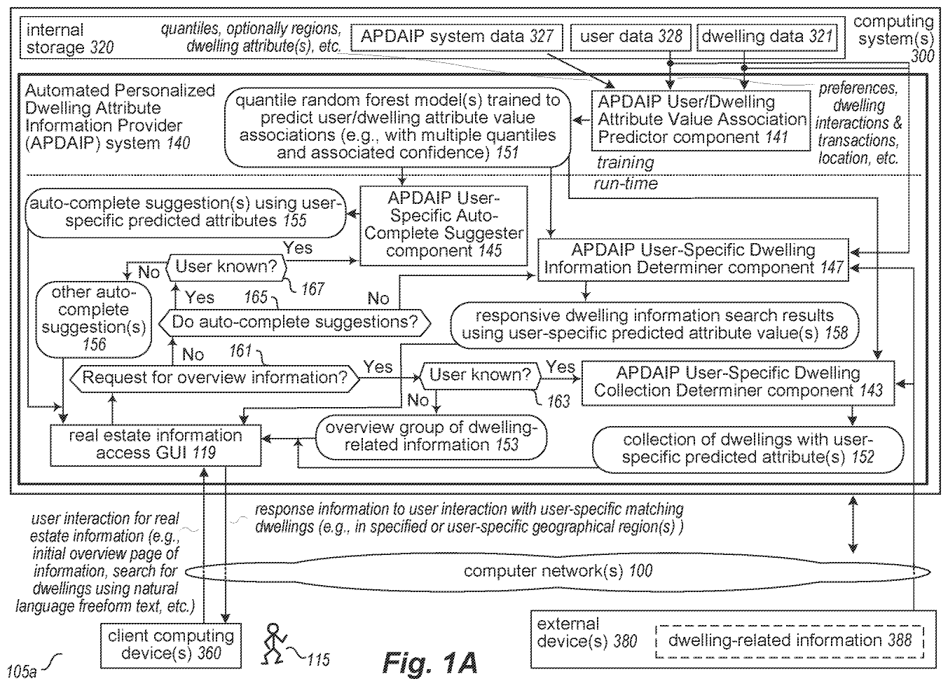

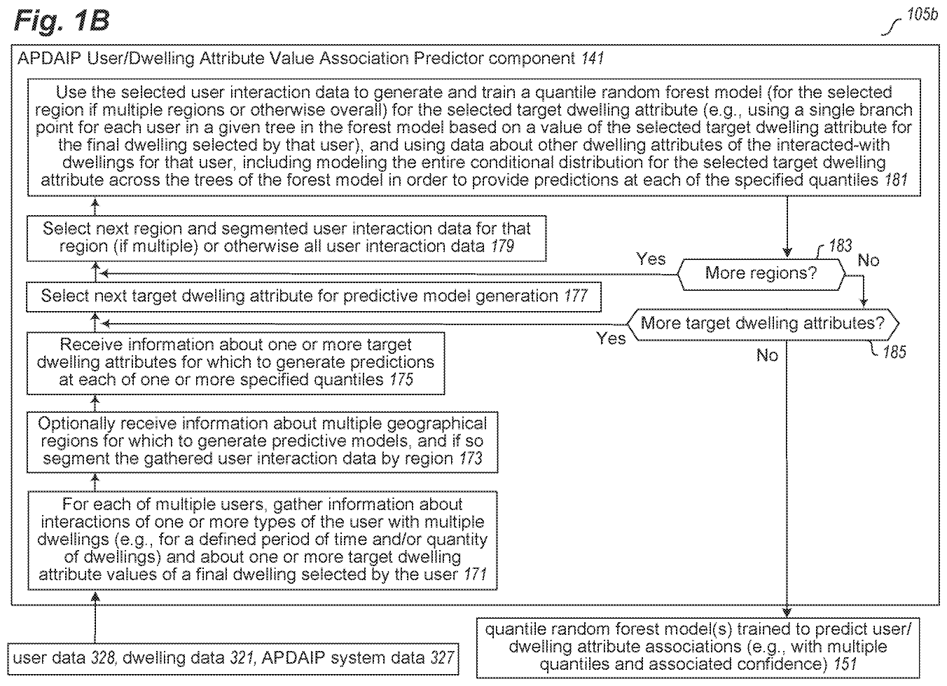

FIGS. 1A-1B are network diagrams illustrating an example system for performing described techniques, including automatically responding to a free-form natural language dwelling information request in a manner that includes automatically determining and using information about one or more user-specific predicted attributes of dwellings that users will occupy in the future.

In particular, FIG. 1A illustrates information 105a about an example embodiment of an APDAIP system 140 executing on one or more computing systems 300, and interacting over one or more computer networks 100 with one or more client computing devices 360, such as to receive query requests from users 115 of the client computing devices for information about dwellings and to provide corresponding responses (e.g., as part of search results). In the illustrated embodiment, the computing systems 300 may store various information on storage 320 that is used by the APDAIP system during operation, including dwelling data 321 about dwellings in one or more geographical areas (e.g., in one or more countries, states, cities, etc.), user data 328 (e.g., user location; prior user interaction data for interactions of one or more types with dwellings via the APDAIP system, and optionally additional received interaction data for further interactions of the user outside the APDAIP system with one or more dwellings, including in-person interactions; user preferences, such as expressly specified and/or implicitly determined from past activities of the user such as viewing or otherwise interacting with information about dwellings; etc.), and APDAIP system data 327 (e.g., stored in one or more databases, such as about geographic regions, target dwelling attributes and other dwelling attributes, quantiles to use with quantile random forests and/or other predictive models, names and locations of POI locations and associated POI categories, data for use in determining distances of one or more types between two or more geographical locations, information for use in segment determination such as word-break and/or phrase-break vocabularies, etc.). The APDAIP system may further optionally retrieve and use other dwelling-related information 388 of one or more types stored externally to the computing systems 300, such as accessed over the one or more computer networks 100 from one or more external computing and/or storage devices 380, whether in addition to or instead of information stored on storage 320, and optionally including information about user interactions outside of the APDAIP system with dwellings.

As one example of operations of the APDAIP system 140, an APDAIP User/Dwelling Attribute Value Association Predictor component 141 performs activities to generate and train one or more quantile random forests models 151 for use in predicting values for one or more target dwelling attributes of final dwellings that users will eventually select to acquire and/or occupy after interactions with other dwellings, including to obtain, as input, dwelling data 321 about dwellings (including attributes of the dwellings), user data 328 (including information about user preferences, prior user dwelling interactions, user location, etc.), and one or more types of APDAIP system data (e.g., information about one or more target dwelling attributes for which to generate and train one or more quantile random forest models, optionally about regions for which to generate and train region-specific quantile random forests models, optionally about one or more user characteristics for which to generate and train characteristic-specific quantile random forest models, optionally quantiles for which to generate information from the trained quantile random forest models, etc.). Additional details are included elsewhere herein related to the generation and training of the one or more quantile random forest models 151, including in FIG. 1B that provides further details related to one example embodiment of such a component 141.

After the one or more quantile random forest models 151 have been generated, the example operations may further include a particular user 115 of one of the client computing devices 360 supplying a query for dwelling-related information (e.g., about one or more criteria in a natural language free-form input for use in identifying particular dwellings of interest) to GUI 119 provided by the APDAIP system. The GUI proceeds to block 161 to determine if the received query is a request for overview information, and if so continues to block 163 to determine if the user is a known user who has sufficient prior interaction data to use in generating one or more user-specific predicted target dwelling attribute values (e.g., for a registered user with such interaction data, or a non-registered user with whom previous interactions have occurred during a current or one or more prior interaction sessions), and if not continues to block 153 to retrieve a non-user-specific overview group of dwelling-related information that is provided to the GUI 119 for use in a response to the received query. If it is instead determined in block 163 that the user has sufficient prior interaction data, the routine instead proceeds to provide the received query to the APDAIP User-Specific Dwelling Collection Determiner component 143. The component 143 uses at least one of the quantile random forest models 151 to generate one or more user-specific predicted target dwelling attribute values based on the prior dwelling interaction data for the user, and uses the one or more predicted target dwelling attribute values to determine one or more collections 152 each associated with at least one predicted target dwelling attribute value, with each collection representing any dwellings having the associated predicted target dwelling attribute value(s) for that collection. The determined collection information 152 is then combined with the overview group of dwelling-related information 153 and provided to the GUI 119 for use in a response to the received query.

If it is instead determined in block 161 that the received query is not a request for overview information, the routine continues instead to block 165 to determine if the received query is a partial query for which to generate one or more auto-complete suggestions, and if so continues to block 167 to determine if the user has sufficient prior interaction data for use in generating one or more user-specific predicted target dwelling attribute values, and if not continues to block 156 to determine one or more auto-complete suggestions 156 that are not specific to the user, and to provide the auto-complete suggestions 156 to the GUI 119 for use in the response to the partial query. If it is instead determined in block 167 that the user has sufficient prior interaction data, the routine continues to block 145 where the query is provided to the APDAIP User-Specific Auto-Complete Suggester component 145. The component 145 uses at least one of the quantile random forest models 151 to generate one or more user-specific predicted target dwelling attribute values based on the prior dwelling interaction data for the user, and uses the one or more predicted target dwelling attribute values to determine one or more user-specific auto-complete suggestions 155 (e.g., to each include or otherwise be based on one or more of the predicted target dwelling attribute values, such as a range of multiple such values or instead a single value), and the user-specific auto-complete suggestions 155 are then provided to the GUI 119 for use in the response to the partial query.

If it is instead determined in block 167 that the query is not a partial query for which to generate one or more auto-complete suggestions, the routine continues instead to perform the APDAIP User-Specific Dwelling Information Determiner component 147. The component 147 then determines if the user has sufficient prior interaction data to generate one or more user-specific predicted target dwelling attribute values, and if so uses at least one of the quantile random forest models 151 to generate one or more user-specific predicted target dwelling attribute values based on the prior dwelling interaction data for the user. The component 147 further analyzes the received query to determine any user-specified criteria (e.g., search criteria, such as dwelling type, geographic region, dwelling attributes and optionally associated values, etc.), analyzes the dwelling data 321 and optionally other dwelling-related information 388 to identify any matching dwellings, and uses the generated one or more user-specific predicted target dwelling attribute values (if any) to rank and/or filter the matching dwellings in order to generate responsive dwelling information search results 158 that use the user-specific predicted target dwelling attribute values if available. The search results 158 are then provided to the GUI 119 for use in response to the query.

The same user may then provide one or more subsequent queries to the GUI 119 as part of an ongoing search interaction session, such as with similar processing performed for the subsequent user queries, and optionally with the context of prior interactions during the session being maintained and used by the APDAIP system. In addition, a user may in some embodiments and situations provide optional user feedback, such as to indicate that one or more incorrect predicted user-specific target dwelling attribute values have been used to respond to the user query, to otherwise provide feedback regarding accuracy of search results response or to provide further clarifying information in response to a corresponding request, to specify further user preferences to be used, etc. If so, such optional user feedback may be forwarded to the components 141 and/or 143 and/or 145 and/or 147, such as to improve future determinations performed by the components. In other embodiments and situations, some or all such feedback may instead be implicit feedback that is determined based on an analysis of subsequent user queries (e.g., to indicate that a prior query response did not provide information that the user was seeking) and/or of prior user queries (e.g., to determine user preferences and/or user location, such as based on patterns in the prior user queries). While the example discussed above involves a single user performing multiple interactions with the APDAIP system as part of an interaction session (e.g., spanning seconds, minutes, hours, days, etc.), it will be appreciated that the APDAIP system may in at least some embodiments and situations be concurrently interacting with many users using different client computing devices, such as to maintain a separate GUI and interaction session history for each such user, and that a new interaction session may be initiated for a user after one or more prior interaction sessions with that user in various manners (e.g., based on a corresponding user instruction, such as to reflect a change in the types of dwelling information of interest; as determined automatically by the APDAIP system, such as to reflect a change in the types of dwelling information being requested, or due to a defined period of time since a last user interaction being exceeded, such as one or more days; etc.).

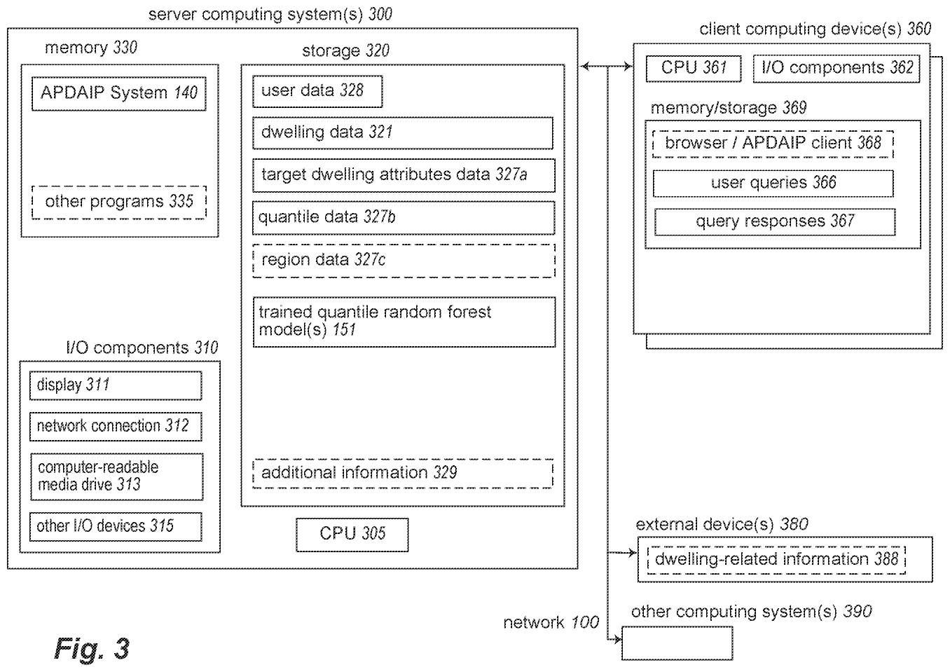

In addition, the computing system(s) 300 may include various other components and functionality, as discussed in greater detail elsewhere herein, including with respect to FIG. 3. The computer networks 100 may similarly be of various types in various embodiments and may include various types of wired and/or wireless segments, including one or more publicly accessible linked networks (e.g., operated by various distinct parties, such as the Internet) and/or a private network (e.g., a corporate or university network that is wholly or partially inaccessible to non-privileged users), including in some cases to have both private and public networks (e.g., with one or more of the private networks having access to and/or from one or more of the public networks).

FIG. 1B continues the example of FIG. 1A, and illustrates information 105b for one example embodiment of the APDAIP User/Dwelling Attribute Value Association Predictor component 141 discussed in FIG. 1A. In particular, in the illustrated embodiment, the component 141 performs various activities to generate and train one or more quantile random forests models 151 for use in predicting values for one or more target dwelling attributes of final dwellings that users will eventually select to acquire and/or occupy after interactions with other dwellings.

In operation, the component 141 receives, as input, dwelling data 321 about various dwellings in one or more geographical regions (including attributes of the dwellings), user data 328 (including information about prior user dwelling interactions, including interactions with dwellings before selecting a final dwelling to acquire and/or occupy, as well as interactions to select a final dwelling to acquire and/or occupy), and one or more types of APDAIP system data (e.g., information about one or more target dwelling attributes for which to generate and train one or more predictive models, optionally about regions for which to generate and train region-specific predictive models, optionally about one or more user characteristics for which to generate and train characteristic-specific predictive models, optionally quantiles for which to generate information from the trained predictive models, etc.). In particular, in block 171 the component 141 gathers information for each of multiple users about interactions of one or more types of that user with multiple dwellings and about one or more target attributes of a final dwelling selected by the user, including in some embodiments and situations to limit the interaction data to a defined period of time, and/or a minimum and/or maximum quantity of dwellings. In block 173, the routine then optionally receives information about multiple geographical regions for which to generate region-specific predictive models (e.g., from the APDAIP system data), and if so also segments gathered user interaction data by region. In block 175, the routine then receives information (e.g., from the APDAIP system data) about one or more target dwelling attributes for which to generate predictions at each of one or more quantiles (e.g., as specified in the APDAIP system data). In block 177, the routine then selects the next target dwelling attribute for which to generate a predictive model, and continues to block 179 to select the next region and associated segmented user interaction data, including to select all of the user interaction data if only a single geographical predictive model will be used to cover all of the available data (e.g., all of a specific country, all of a specific state, all of a specific continent, etc.).

In block 181, the routine then uses the selected user interaction data to generate and train a predictive quantile random forest model for the selected region and selected target dwelling attribute, including using data to generate the branch points of the various decision trees of the forest based on dwelling attribute values of the dwellings that are interacted with before final dwellings are selected, and using the values for the selected target dwelling attribute in the leaf nodes of the decision trees, so as to model the entire conditional distribution for the selected target dwelling attribute across the trees of the forest model in order to provide predictions at each of multiple quantiles (if multiple quantiles are specified). In block 183, the routine then determines if there are more geographical regions for which to generate a predictive model for the selected target dwelling attribute, and if so returns to block 179 to select the next region and its associated segmented user interaction data. Otherwise the routine continues to block 185 to determine if there are more target dwelling attributes for which to generate one or more predictive models, and if so returns to block 177 to select the next target dwelling attribute. Otherwise, the routine continues to output the generated one or more quantile random forest models 151 as output of the component 141. In addition, while not illustrated in this example, in some embodiments user characteristic data may further be used for segmenting user interaction data and generating separate predictive models associated with different values for one or more user characteristics (e.g., gender, age, etc.).

It will be appreciated that various details are provided with respect to FIGS. 1A-1B for illustrative purposes, and are not intended to limit the scope of the invention unless otherwise indicated. Similarly, additional exemplary details are provided with respect to FIGS. 2A-2E and elsewhere herein, and such details are similarly provided for illustrative purposes and are not intended to limit the scope of the invention unless otherwise indicated.

FIGS. 2A-2E illustrate examples of performing described techniques, including automatically determining and using information about one or more user-specific predicted attributes of dwellings that users will occupy in the future.

In particular, FIG. 2A illustrates information 205a including an example client computing device 360 (in this example, a smartphone) that is being used by a user (not shown) to interact with a GUI provided by the APDAIP system, with current information 206 displayed in the GUI. In this example, the current information 206 corresponds to overview dwelling-related information provided in response to a previous request (e.g., a request to load a home page of a corresponding Web site), with the displayed information including a search box 215a, a user-selectable control 210a via which the user may sign in, and various groups of information 220 and 221 related to multiple types of dwelling-related information. In this example, the displayed information includes a first group of information 220a to show information about specific example houses near the user's location (e.g., based on an automatically determined location of the user or the user's client device), which in this example includes three example houses and user-selectable controls to view additional houses of that type-information about other types of dwellings (e.g., apartments, condominiums, etc.) may be provided, whether in addition to or instead of houses. The example provided information further includes a second group of information 220b about trending houses in a geographical area of the user (e.g., that were viewed and saved the most in the prior 24 hours), which again in this example includes three example houses and corresponding user-selectable controls to view additional houses of that type—in a similar manner to information 220a, information about other types of dwellings may be provided, whether in addition to or instead of houses. The example provided information also includes a third group of information 220c about houses expected to sell soon in a geographical area of the user, which in this example also includes three example houses and corresponding user-selectable controls to view additional houses of that type—in a similar manner to that of information 220a and 220b, information about other types of dwellings may be provided, whether in addition to or instead of houses. The example provided information further includes additional information 222 related to real estate but not specific to particular types of houses, such as general information about selling or renting dwellings, about budget and financing, about finding a real estate agent, etc. In this example, since the user is not signed in and the APDAIP system does not have sufficient prior interactions with the user during a current interaction session, the initially provided information does not include information based on any predicted target dwelling attribute values of the final dwelling that the user will eventually select.

FIG. 2B continues the example of FIG. 2A, and illustrates information 205b showing updated overview dwelling-related information after the user has logged in 210b, which again includes the search box 215a, but in this example further includes additional dwelling-related information that is specific to the user. In particular, in this example, the provided information includes a group of information 220d about houses that are recommended for the user in a selected geographical region (e.g., a city in which that user has previously interacted with dwellings, a city in which the user is currently located or currently lives or has specified as a preference, etc.) based on prior dwelling interactions by the user, but which are not specific to any predicted target dwelling attribute values for the user—in this example, the information 220d includes information about three houses and user-selectable controls with which to view additional houses of that type. In addition, the provided information further includes multiple additional groups of information that are based at least in part on one or more predicted target dwelling attribute values for the user using prior interaction data for the user with other dwellings, including information 220e about houses in the specified geographical region for a target dwelling attribute of dwelling square footage and a predicted value of 2500 square feet, which in this example also includes information about three houses and user-selectable controls with which to view additional houses of that type—the determination of houses that are ‘around’ 2500 square feet may include using a range of square footage values with lower and upper bounds that are not shown, while in other embodiments and situations the information 220e may explicitly indicate the lower and upper bounds of a range of values that are used. In a similar manner, information 220f about houses in the specified geographical region for a target dwelling attribute of listing price and a predicted value of “$YYY, YYY”, which in this example also includes information about three houses and user-selectable controls with which to view additional houses of that type—the determination of houses that are ‘around’ “$YYY, YYY” may include using a range of listing price values with lower and upper bounds that are not shown, while in other embodiments and situations the information 220f may explicitly indicate the lower and upper bounds of a range of values that are used. It will be appreciated that other types of user-specific predicted target dwelling attribute values may similarly be used to include information about other types of dwellings. In addition, while the example provided information in FIGS. 2A-2B for the building collections 220 are shown with information about specific dwellings, in other embodiments and situations the information for a collection may instead include a single user-selectable control that indicates the type of dwelling information but without showing information about specific dwellings, and with the information about the corresponding specific dwellings for the collection available to the user upon selection of the user-selectable control.

FIG. 2C continues the examples of FIGS. 2A-2B, and illustrates information 205c showing additional examples of using user-specific predicted target dwelling attribute values to provide information to a user, which in this example includes providing auto-complete suggestions 219 to the user based on a partial query entered in the search box 215a. In particular, in this example the suggestions 219 are based in part on target dwelling attributes that include dwelling square footage, quantity of dwelling bathrooms, quantity of dwelling bedrooms, dwelling listing price, dwelling total monthly payment, etc., including to show variations with respect to geographical region, the use of explicit ranges of predicted values or a single indicated predicted value (e.g., a median or mean value), etc. While not illustrated, the user may select one of the suggestions 219 to initiate a completed query with that information, with corresponding results information shown to the user in an updated GUI.

FIG. 2D continues the examples of FIGS. 2A-2C, and illustrates information 205d showing additional examples of using user-specific predicted target dwelling attribute values to provide information to a user, which in this example includes receiving completed queries in the search box and providing corresponding search results information that is ranked and/or filtered based on the user-specific predicted target dwelling attribute values. In particular, in this example a first query 215b is shown related to houses around 2500 square feet in a specified geographical region, and the corresponding search results 220g are shown in an order that may be ranked at least in part on one or more predicted values for the user for one or more other target dwelling attributes (not shown), as well as based at least in part on a degree of matching to the specified criteria of the query. In a similar manner, a second example query 215c is shown related to apartments around a particular monthly rental price in a specified geographical region, and the corresponding search results 220h are shown in an order that again may be ranked at least in part on one or more predicted values for the user for one or more other target dwelling attributes (not shown), as well as based at least in part on a degree of matching to the specified criteria of the query. It will be appreciated that other types of queries and resulting information may similarly be received and provided in other examples.

FIG. 2E continues the examples of FIGS. 2A-2D, and illustrates information 205e showing an example quantile random forest model 151, which in this example is generated for a target dwelling attribute of dwelling square footage, but is not specific to a particular geographical region or a user characteristic. In this example, the model 151 includes numerous individual decision trees 221, with part of one specific decision tree 221a shown in additional detail, with the decision tree 221a corresponding to a random subset of the input data. In this example, the branching from the root node 201 of the decision tree 221a is based on values of a dwelling attribute corresponding to quantity of bedrooms, with each of the three nodes 202a-c at the first level having branching for a next level based on another dwelling attribute—in this example, the second level is shown only for node 202b, with its branching corresponding to a dwelling attribute for quantity of bathrooms and having two corresponding nodes 203a-b. The illustrated branching continues through several levels, including for node 203b to have a next branching level based on a dwelling attribute of property size, with two corresponding nodes 204a-b shown in this example. The final leaf nodes 2XXa-n in this example each are associated with different groups of users from the subset of training data used for this decision model 211a, and corresponding to the users in that subset of training data whose user-dwelling interaction data causes them to reach that leaf node in the tree (e.g., using average or other aggregate values for the various dwellings that a user has previously interacted with before selecting the final dwelling), and with each leaf node associated with the value of the target dwelling attribute for the final dwellings selected by the associated users for that leaf node (e.g., using an actual value of the target dwelling attribute from each user's transaction for their respective final dwelling). It will be appreciated that each decision tree may have a separate branching structure corresponding to the subset of training data used for its generation and training. In addition, while not illustrated in this example, in some embodiments user characteristic data may further be used for branching attributes.

It will be appreciated that the examples of FIGS. 2A-2E are provided for illustrative reasons only, and are not intended to limit the scope of the invention. For example, a variety of other combinations of natural language free-form search terms may be used in other embodiments and situations.

In addition, further details related to at least some operations of the APDAIP system and its components are included in the following, each of which is herein incorporated by reference in its entirety: U.S. Provisional Patent Application No. 63/611,196, entitled “Automated Tool For Generating And Providing Housing-Related Information” and filed Dec. 17, 2023; U.S. Provisional Patent Application No. 63/625,139, entitled “Automated Tool For Determining And Providing Building Information For Multiple Partially Described Proximate Geographical Regions” and filed Jan. 25, 2024; and U.S. Provisional Patent Application No. 63/625,199, entitled “Automated Tool For Determining And Providing Information About Dwellings Within Geographical Regions That Are Determined Specific To Indicated Locations” and filed Jan. 25, 2024.

For illustrative purposes, some embodiments are described herein in which specific types of information are acquired, used and/or presented in specific ways using specific types of data structures and by using specific types of devices-however, it will be understood that the described techniques may be used in other manners in other embodiments, and that the invention is not limited to exemplary details provided. As one non-exclusive example, specific types of data structures and algorithms are generated and/or used in specific manners in some embodiments, but it will be appreciated that other types of information may be generated and used in other manners in other embodiments, including for types of information other than dwelling information. Similarly, while particular user interface display and interaction techniques are shown, other user interaction techniques may be used in other embodiments. In addition, various details are provided in the drawings and text for exemplary purposes, but are not intended to limit the scope of the invention—for example, sizes and relative positions of elements in the drawings are not necessarily drawn to scale, with some details omitted and/or provided with greater prominence (e.g., via size and positioning) to enhance legibility and/or clarity, and identical reference numbers may be used in the drawings to identify the same or similar elements or acts.

FIG. 3 is a block diagram illustrating an embodiment of one or more server computing systems 300 executing an implementation of an APDAIP system 140, such as in a manner similar to that of FIGS. 1A-1B and with additional hardware details illustrated—the server computing system(s) and APDAIP system may be implemented using a plurality of hardware components that form electronic circuits suitable for and configured to, when in combined operation, perform at least some of the techniques described herein. In the illustrated embodiment, each server computing system 300 includes one or more hardware central processing units (“CPU”) or other hardware processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.).

The server computing system(s) 300 and executing APDAIP system 140 may communicate with other computing systems and devices via one or more networks 100 (e.g., the Internet, one or more cellular telephone networks, etc.), such as user client computing devices 360 (e.g., used to supply queries; receive responsive answers; and use the received answer information, such as to display or otherwise present answer information to users of the client computing devices and/or to implement further automated activities, such as to access other functionality provided by the APDAIP system), optionally other external devices 380 (e.g., used to store and provide dwelling information of one or more types), and optionally other computing systems 390.

In the illustrated embodiment, an embodiment of the APDAIP system 140 executes in memory 330 in order to perform at least some of the described techniques, such as by using the processor(s) 305 to execute software instructions of the system 140 in a manner that configures the processor(s) 305 and computing system 300 to perform automated operations that implement those described techniques. The illustrated embodiment of the APDAIP system may include one or more components, not shown, to each perform portions of the functionality of the APDAIP system, and the memory may further optionally execute one or more other programs 335. The APDAIP system 140 may further, during its operation, store and/or retrieve various types of data on storage 320 (e.g., in one or more databases or other data structures), such as various types of user data 328, dwelling data 321 (e.g., dwelling attributes and associated values, etc.), target dwelling attribute data 327a, quantile data 327b, optionally region data 327c, one or more trained predictive models 151 (e.g., quantile random forest models) and/or various other types of optional additional information 329.

Some or all of the user client computing devices 360 (e.g., mobile devices), external devices 380, and other computing systems 390 may similarly include some or all of the same types of components illustrated for server computing system 300. As one non-limiting example, the computing devices 360 are each shown to include one or more hardware CPU(s) 361, I/O components 362, and memory and/or storage 369, with a browser and/or APDAIP client program 368 optionally executing in memory to interact with the APDAIP system 140 and present or otherwise use query responses 367 that are received from the APDAIP system for submitted user queries 366. While particular components are not illustrated for the other devices/systems 380 and 390, it will be appreciated that they may include similar and/or additional components.

It will also be appreciated that computing system 300 and the other systems and devices included within FIG. 3 are merely illustrative and are not intended to limit the scope of the present invention. The systems and/or devices may instead each include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, and various other consumer products that include appropriate communication capabilities. In addition, the functionality provided by the illustrated APDAIP system 140 may in some embodiments be distributed in various components, some of the described functionality of the APDAIP system 140 may not be provided, and/or other additional functionality may be provided.

It will also be appreciated that, while various items are illustrated as being stored in memory or on storage while being used, these items or portions of them may be transferred between memory and other storage devices, such as for purposes of execution, memory management, data integrity, etc. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the APDAIP system 140 executing on server computing systems 300) and/or data structures, such as by execution of software instructions of the one or more software programs and/or by storage of such software instructions and/or data structures, and such as to perform algorithms as described in the flow charts and other disclosure herein. Furthermore, in some embodiments, some or all of the systems and/or components may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

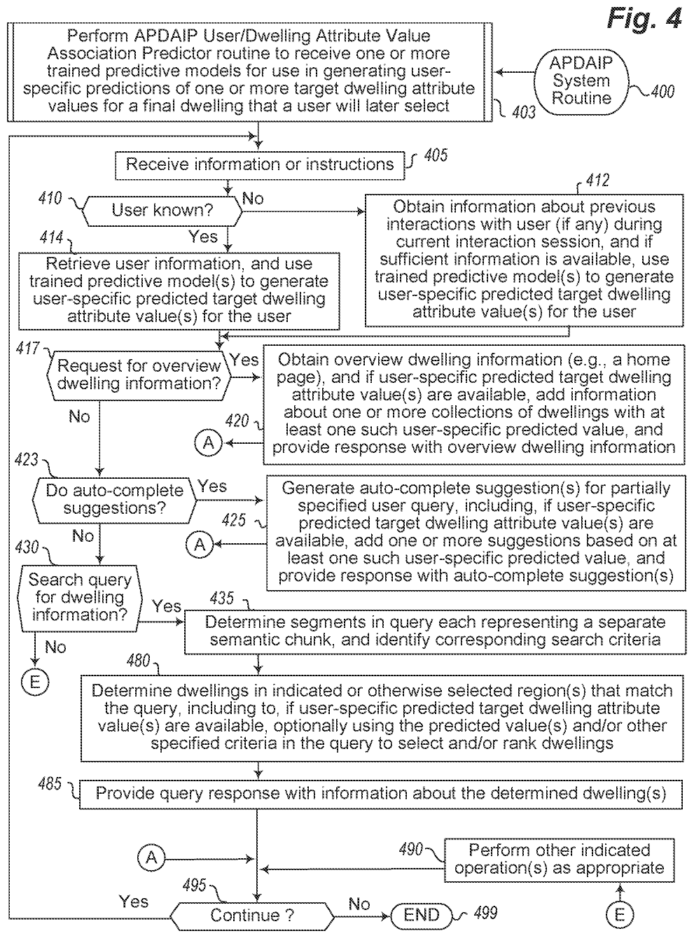

FIG. 4 is a flow diagram of an example embodiment of an APDAIP system routine 400. The routine may be provided by, for example, execution of the APDAIP system 140 of FIGS. 1A-1B, and/or the APDAIP system 140 of FIG. 3, and/or corresponding functionality discussed with respect to FIGS. 2A-2E and elsewhere herein, such as to perform automated operations related to automatically determining and using information about one or more user-specific predicted attributes of dwellings that users will occupy in the future. In the illustrated embodiment, the routine interacts with a single user at a time to provide dwelling response information to search queries and other requests from that user, but it will be appreciated that the routine may interact in a similar manner with multiple users (e.g., sequentially or concurrently), and that the routine may in other embodiments perform similar types of activities for other types of information.

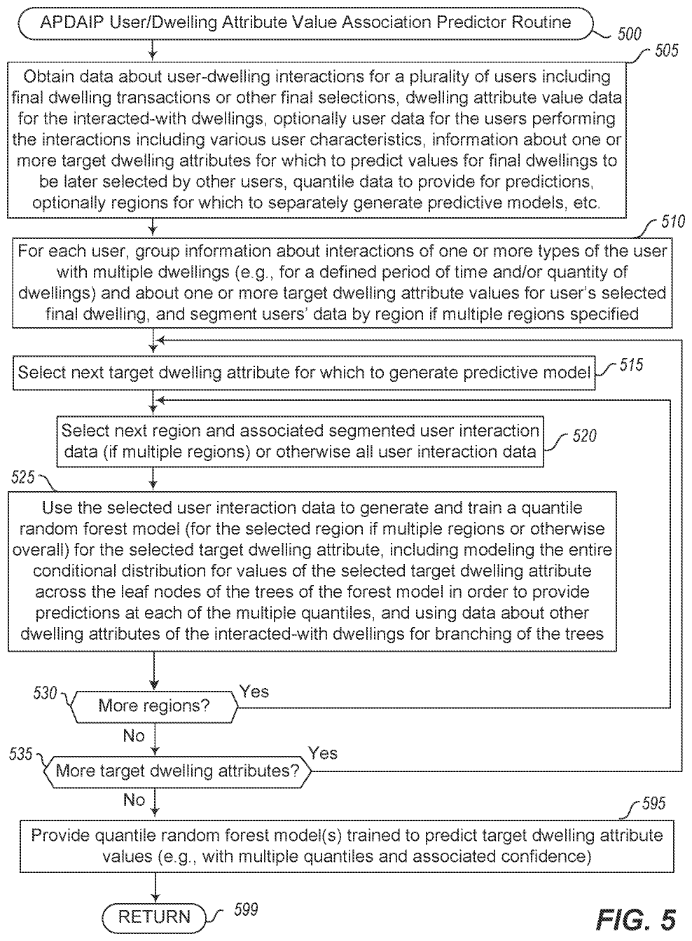

In the illustrated embodiment, the routine 400 begins at 403, where it performs the APDAIP User/Dwelling Attribute Value Association Predictor routine to receive one or more trained predictive models for use in generating user-specific predictions of one or more target dwelling attribute values for a final dwelling that the user will later select, with one example of such a routine discussed further with respect to FIG. 5. The routine continues to block 405, where it receives information or instructions, such as a request from the user. In block 410, the routine determines a request is received in block 405 from a user who is known (e.g., is a registered user who is logged in) and has sufficient data about prior user-dwelling interactions to enable generation of one or more predicted target dwelling attribute values for the user, and if so continues to block 414 where it retrieves the user information about such prior user-dwelling interactions, and it supplies that dwelling data as input to at least one trained predictive model to generate the one or more user-specific predicted target dwelling attribute values for the user. If it is instead determined in block 10 that the request is not from a user who is known, the routine continues instead to block 412, where it obtains information about previous interactions with the user (if any) during a current interaction session, and if sufficient information is available about user-dwelling interactions (e.g., at least a minimum number of interacted-with dwellings), it supplies that dwelling data as input to at least one trained predictive model to generate the one or more user-specific predicted target dwelling attribute values for the user.

After blocks 412 or 414, the routine continues to block 417, where it determines if a request is received in block 405 for overview dwelling-related information, and if so continues to block 420, where it obtains overview dwelling information (e.g., a homepage), and if one or more user-specific predicted target dwelling attribute values are available, generates and adds information to the overview dwelling information about one or more collections of dwellings each having at least one such predicted attribute value, and then provides a response to the request with the overview dwelling information. If it is instead determined in block 417 that a request is not received in block 405 for overview dwelling-related information, the routine continues to block 423, where determines if the request or other information received in block 405 corresponds to a partial query for which to generate one or more auto-complete suggestions, and if so continues to block 425, where it generates one or more auto-complete suggestions for the partial query, including, if one or more user-specific predicted target dwelling attribute values are available, generates and adds one or more user-specific suggestions that are each based on at least one such predicted value, and then provides a response with the auto-complete suggestion(s) for presentation to the user who is supplying the partial query.

If it is instead determined in block 423 that a partial query request is not received in block 405 for which to generate one or more auto-complete suggestions, the routine continues instead to block 430 to determine if the information or instructions received in block 405 is a completed search query for dwelling information that includes one or more specified search criteria, and if not continues to block 490. Otherwise, the routine continues to block 435, where determines segments in the query each representing a separate semantic chunk, and identifies one or more corresponding search criteria for the semantic chunks. In block 480, the routine then determines dwellings in an indicated or otherwise selected one or more regions that match the specified criteria of the query, including to, if one or more user-specific predicted target dwelling attribute values are available, optionally use one or more of the predicted values and/or other specified criteria in the query to select and/or rank dwellings to be included in the final search results. In block 485, the routine then provides the query response with the information about the determined one or more dwellings.

If it is instead determined in 430 that the received instructions or other information is not a completed search query for dwelling information, the routine in block 490 proceeds to perform one or more other indicated operations as appropriate, with non-exclusive examples of such other operations including retrieving and providing previously determined or generated information (e.g., previous user queries, previously determined responses to user queries, etc.), receiving and storing information for later use (e.g., information about dwelling data 321, user data 328, APDAIP system data 327, etc.), responding to other types of search queries (e.g., using user-specified filters), receiving and using feedback from a user in response to provided query responses in block 485, providing information about how one or more previous query responses were determined, performing housekeeping operations, etc.

After blocks 420 or 425 or 485, the routine continues to block 495 to determine whether to continue, such as until an explicit indication to terminate is received (or alternatively only if an explicit indication to continue is received). If it is determined to continue, the routine returns to block 405 to await further information or instructions from the same user, and if not continues to block 499 and ends.

FIG. 5 is a flow diagram of an example embodiment of an APDAIP User/Dwelling Attribute Value Association Predictor routine 500. The routine may be provided by, for example, execution of the APDAIP User/Dwelling Attribute Value Association Predictor component 141 of FIGS. 1A-1B and/or a corresponding component (not shown) of the APDAIP system 140 of FIG. 3 and/or with respect to corresponding functionality discussed with respect to FIGS. 2A-2E and elsewhere herein, such as to generate and train one or more quantile random forests models for use in predicting values for one or more target dwelling attributes of final dwellings that users will eventually select to acquire and/or occupy after interactions with other dwellings. In addition, in at least some situations, the routine 500 may be performed based on execution of block 403 of FIG. 4, with resulting information provided and execution control returning to that location when the routine 500 ends—in other embodiments, the routine may be invoked in other manners. In this example, the routine 500 is performed using particular ways to generate particular types of predictive models (e.g., quantile random forest models), but in other embodiments may use other techniques to generate the same or other types of predictive models, whether in addition to or instead of the illustrated types of techniques.

The illustrated embodiment of the routine 500 begins at block 505, where data is obtained about user-dwelling interactions for a plurality of users that includes final dwelling transactions or other final selections of dwellings by those users, dwelling attribute value data for the interacted-with dwellings, optionally user data for the users performing the transactions such as for various user characteristics, information about one or more target dwelling attributes for which to predict values for final dwellings to later be selected by other users, quantile data to provide for use in generating predictions at those quantiles, and optionally data about regions for which to separately generate predictive models. In block 510, the routine then, for each user, with information about interactions of one or more types of that user with multiple dwellings (e.g., for a defined period of time and/or a defined quantity of dwellings) and about one or more target dwelling attribute values for that user's selected final dwelling, as well as to optionally segment the data for the various users by region if multiple regions are specified. In some embodiments and situations, the users' data may be segmented by one or more user characteristics, whether in addition to or instead of one or more regions, as discussed in greater detail elsewhere herein.

After block 510, the routine continues to block 515, where it selects the next target dwelling attribute for which to generate one or more corresponding predictive models, and in block 520 to select the next region and associated segmented user interaction data (if there are multiple regions) or otherwise all the user interaction data. In block 525, the routine then uses the selected user interaction data to generate and train a quantile random forest model (for the selected region if there are multiple regions or otherwise overall) for the selected target dwelling attribute, including modeling the entire conditional distribution for values of the selected target dwelling attribute across the leaf nodes of the trees of the forest model in order to enable predictions at each of the multiple quantiles, and using data about other dwelling attributes of the interacted-with dwellings to determine branching of the various decision trees of the forest model. In block 530, the routine then determines if there are more regions for which to generate predictive models, and if so returns to block 520 to select the next such region. Otherwise, the routine continues to block 535 where determines if there are more target dwelling attributes for which to generate one or more predictive models, and if so returns to block 515 to select the next such target dwelling attribute. If there are no more target dwelling attributes in block 535, the one or more generated and trained quantile random forest models are then provided as output in block 595, and the routine then continues to block 599 and returns, such as to return to the flow of FIG. 4 at block 403 if invoked from there.

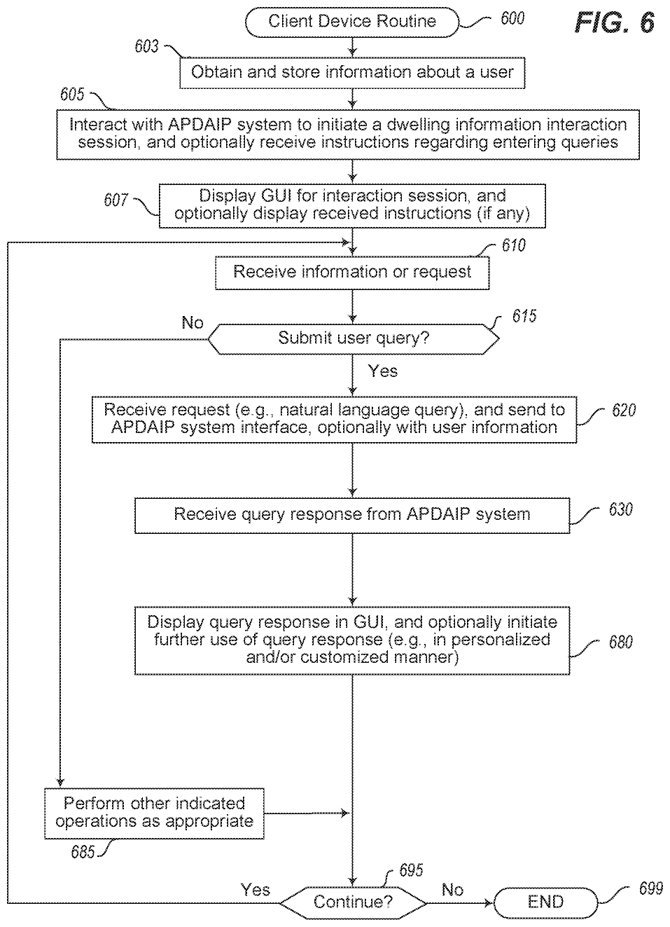

FIG. 6 is a flow diagram of an example embodiment of a client device routine 600. The routine may be provided by, for example, operations of a client computing device 360 of FIGS. 1A-1B and/or a client computing device 360 of FIG. 3 and/or with respect to corresponding functionality discussed with respect to FIGS. 2A-2E and elsewhere herein, such as to interact with users or other entities who submit queries (or other requests or information) to the APDAIP system, to receive responsive answers (or other information) from the APDAIP system, and to optionally use the received information in one or more manners (e.g., to automatically initiate follow-up activities in accordance with a received responsive answer).

The illustrated embodiment of the routine 600 begins at block 603, where information is optionally obtained and stored about the user, such as for later use in personalizing or otherwise customizing further actions to that user. The routine then continues to block 605 to interact with the APDAIP system to initiate an interaction session (e.g., in response to a corresponding instruction from the user), as well as to optionally receive a greeting and/or introductory instructions regarding using a GUI of the APDAIP system. In block 607, the routine then displays a GUI for the interaction session, and optionally displays the received greeting and/or introductory instructions, if any. The routine then continues to perform blocks 610-685 as part of participating in the interaction session.

In particular, the routine continues to block 610 after block 607, where it waits until information or a request is received from the user. In block 615, the routine determines if the information or request received in block 610 is a request to submit, such as a search query in a natural language format (e.g., freeform text), and if not continues to block 685. Otherwise, the routine continues to block 620, where it sends the received query to the APDAIP system interface, optionally along with additional information about the user from block 603, to obtain a corresponding responsive answer—in other embodiments, the routine may further modify the received user query to personalize and/or customize the information to be provided to the APDAIP system (e.g., to add information specific to the user, such as location, demographic information, preference information, etc.). In block 630, the routine then receives a responsive answer to the query from the APDAIP system. In block 680, the routine then displays the received query response in the GUI, and optionally initiates further use of the query response in one or more manners (e.g., in a manner that is personalized and/or customized for the user)—in some embodiments, the further initiated activities may include invoking of other functionality of the APDAIP system, such as to initiate an inspection process for a selected dwelling indicated in dwelling information search results, to initiate a mortgage application process for a selected dwelling indicated in dwelling information search results, to initiate matching the user with a real estate professional as part of a housing search based on corresponding response information received from the APDAIP system, etc.

In block 685, the routine instead performs one or more indicated operations as appropriate other than receiving and submitting a query, with non-exclusive examples including sending information to the APDAIP system of other types, receiving and storing user data for later use in personalization and/or customization activities, receiving and responding to requests for information about previous user queries and/or corresponding responsive answers for a current user and/or client device, receiving and responding to indications of one or more housekeeping activities to perform, etc. After blocks 680 or 685, the routine continues to block 695 to determine whether to continue, such as until an explicit indication to terminate is received (or alternatively only if an explicit indication to continue is received). If it is determined to continue, the routine returns to block 610, and if not continues to block 699 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the claims that are specified and the elements recited therein. In addition, while certain aspects of the invention may be presented at times in certain claim forms, the inventors contemplate the various aspects of the invention in any available claim form. For example, while only some aspects of the invention may be recited at a particular time as being embodied in a computer-readable medium, other aspects may likewise be so embodied.

1. A computer-implemented method comprising:
generating, by one or more computing devices, a trained quantile random forest model that models, for one or more target attributes of houses that first users will later select to acquire before the first users have selected those houses, a distribution of values for the one or more target attributes across a plurality of leaf nodes of a plurality of decision trees of the quantile random forest model, wherein the generating of the trained quantile random forest model includes using, to generate the plurality of decision trees, training data about interactions of a plurality of other second users with a plurality of houses and about a plurality of values of multiple attributes for the plurality of houses and about a final value for each of the one or more target attributes of particular houses that the plurality of second users later select to acquire, and wherein the quantile random forest model is trained to predict values for each of a plurality of quantiles for each of the one or more target attributes;
using, by the one or more computing devices, the generated trained quantile random forest model to predict, for a target first user separate from the plurality of second users and before the target first user has selected a final house to occupy, a range of values for each of the one or more target attributes of the final house that the target first user will later select, including:
receiving, by the one or more computing devices, a request from the target first user with one or more specified criteria about houses;
obtaining, by the one or more computing devices, information about multiple values of the multiple attributes for a group of houses with which the target first user has interacted; and
supplying, by the one or more computing devices, the multiple values of the multiple attributes for the group of houses as input to the generated trained quantile random forest model to obtain the predicted range of values for each of the one or more target attributes of the final house, including obtaining multiple predicted quantile values for each of the one or more target attributes, and using the multiple predicted quantile values for each of the one or more target attributes to set a lower bound quantile and an upper bound quantile for the predicted range of values for that target attribute;
determining, by the one or more computing devices and using the predicted range of values for each of the one or more target attributes of the final house, one or more houses that satisfy the specified criteria and have values for each of the one or more target attributes in the predicted range for that target attribute; and
presenting, by the one or more computing devices and in a displayed graphical user interface, information to the target first user in response to the request that includes indications of the determined one or more houses.

2. The computer-implemented method of claim 1 wherein the received request from the target first user is a search request, wherein the presented information includes search results with indications of multiple determined houses, wherein the one or more target attributes include at least one of a dwelling size or a quantity of bathrooms or a quantity of bedrooms, and wherein the group of houses with which the target first user has interacted include houses for which the target first user has selected to view information during a defined prior period of time.

3. The computer-implemented method of claim 2 wherein obtaining of the predicted range of values for each of the one or more target attributes of the final house from the generated trained quantile random forest model includes obtaining at least one confidence value for the predicted range of values for each of the one or more target attributes of the final house, and adjusting at least one of the selected lower bound quantile or the selected upper bound quantile for at least one of the target attributes based on the confidence value.

4. A computer-implemented method comprising:
generating, by one or more computing devices, a trained quantile random forest model that models, for one or more target attributes of dwellings that first users will later select to occupy before the first users have selected those dwellings, a distribution of values for the one or more target attributes across a plurality of leaf nodes of a plurality of decision trees of the quantile random forest model, wherein the generating of the trained quantile random forest model includes using, to generate the plurality of decision trees, training data about interactions of a plurality of other second users with a plurality of dwellings and about a plurality of values of multiple attributes for the plurality of dwellings and about a final value for each of the one or more target attributes of particular dwellings that the plurality of second users later select to occupy;
using, by the one or more computing devices, the generated trained quantile random forest model to predict, for a target first user separate from the plurality of second users and before the target first user has selected a final dwelling to occupy, a range of values for each of the one or more target attributes of the final dwelling that the target first user will later select, including:
receiving, by the one or more computing devices, a request from the target first user with one or more specified criteria about dwellings;
obtaining, by the one or more computing devices, information about multiple values of the multiple attributes for a group of dwellings with which the target first user has interacted; and
supplying, by the one or more computing devices, the multiple values of the multiple attributes for the group of dwellings as input to the generated trained quantile random forest model to obtain the predicted range of values for each of the one or more target attributes of the final dwelling, including obtaining multiple predicted quantile values for each of the one or more target attributes, and using the multiple predicted quantile values for each of the one or more target attributes to set lower and upper bounds for the predicted range of values for that target attribute;
determining, by the one or more computing devices and using the predicted range of values for each of the one or more target attributes of the final dwelling, one or more dwellings that satisfy the specified criteria and have values for each of the one or more target attributes in the predicted range for that target attribute; and
providing, by the one or more computing devices, information to the target first user in response to the request that includes indications of the determined one or more dwellings.

5. The computer-implemented method of claim 4 wherein obtaining of the predicted range of values for each of the one or more target attributes of the final dwelling includes determining a lower bound of the predicted range to be a first selected quantile and determining an upper bound of the predicted range to be a second selected quantile.

6. The computer-implemented method of claim 5 wherein obtaining of the predicted range of values for each of the one or more target attributes of the final dwelling from the generated trained quantile random forest model further includes obtaining at least one confidence value for values of at least one predicted range of values, and adjusting at least one of the determined lower bound or the determined upper bound for at least one of the target attributes based on the at least one confidence value.

7. The computer-implemented method of claim 4 wherein the received request is a request for overview information of multiple types about dwellings, wherein the determining of the one or more dwellings includes determining a collection of multiple dwellings having values for each of the one or more target attributes matching the predicted range of values for that target attribute, and wherein the providing of the information includes generating a page of information that includes an indication of the determined collection of multiple dwellings and further includes additional information of one or more types.

8. The computer-implemented method of claim 4 wherein the received request is a partial request that is not completed, wherein the method further comprises, before completion of the partial request by the target first user and before the determining of the one or more dwellings:
providing one or more suggestions to the target first user for completing the partial request that are each based on the predicted range of values for at least one of the one or more target attributes; and
receiving a completed request from the target first user that uses at least one of the provided one or more suggestions,
and wherein the determining of the one or more dwellings is performed in response to the receiving of the completed request.

9. The computer-implemented method of claim 4 wherein the received request is a search request, wherein the determining of the one or more dwellings further includes determining multiple dwellings that satisfy the one or more specified criteria, and using the predicted values for each of the one or more target attributes to at least one of filter or rank the determined multiple dwellings, and wherein the providing of the information includes providing search results using the at least one of the filtered or ranked determined multiple dwellings.

10. The computer-implemented method of claim 4 wherein the one or more target attributes include at least one of a dwelling size or a quantity of bathrooms or a quantity of bedrooms, and wherein the group of dwellings with which the target first user has interacted include dwellings for which the target first user has selected to at least one of view information about the dwelling, or save the dwelling for later retrieval, or select the dwelling for further in-person review.

11. The computer-implemented method of claim 4 wherein the one or more target attributes include at least one of an acquisition price for the final dwelling or a monthly monetary amount for acquisition of the final dwelling.

12. The computer-implemented method of claim 4 wherein the generating of the trained quantile random forest model includes generating multiple trained models each specific to at least one of a geographical region or a user characteristic, and wherein the supplying of the multiple values of the multiple attributes for the group of dwellings as input is performed to one of the multiple trained models that is selected based on information specific to at least one of the target first user or to the one or more specified criteria.

13. The computer-implemented method of claim 4 wherein the request is a search request received from a client device, wherein the providing of the information with the indications of the determined one or more dwellings includes transmitting, by the one or more computing devices, search results that include the information with the indications of the determined one or more dwellings over one or more computer networks to the client device for display on the client device, wherein the group of dwellings with which the target first user has interacted include at least one of dwellings with which the target first user has interacted during a defined prior period of time, or a defined quantity of dwellings with which the target first user has interacted most recently, and wherein the method further comprises weighting information about the multiple values of the multiple attributes for the dwellings of the group based on recency of interactions by the target first user.

14. A system comprising:
one or more hardware processors of one or more computing devices; and
one or more memories with stored instructions that, when executed by at least one of the one or more hardware processors, cause at least one computing device of the one or more computing devices to perform automated operations including at least:
generating a trained quantile random forest model that models, for one or more target attributes of one or more buildings that one or more first users will later select to acquire before the one or more first users have selected those one or more buildings, a distribution of values for the one or more target attributes across a plurality of leaf nodes of a plurality of decision trees of the quantile random forest model, wherein the generating of the trained quantile random forest model includes using, to generate the plurality of decision trees, training data about interactions of a plurality of other second users with a plurality of buildings and about a plurality of values of multiple attributes for the plurality of buildings and about a final value for each of one or more target attributes of particular buildings that the plurality of second users later select to acquire;
using the trained quantile random forest model to predict, for a target first user separate from the plurality of second users and before the target first user has selected a final building to acquire, values for each of the one or more target attributes of the final building that the target first user will later acquire, including:
receiving, from the target first user, a request for information about buildings;
obtaining information about multiple values of the multiple attributes for a group of buildings with which the target first user has interacted; and
supplying the multiple values of the multiple attributes for the group of buildings as input to the trained quantile random forest model to obtain the predicted values for each of the one or more target attributes of the final building, including obtaining multiple predicted quantile values for each of the one or more target attributes, and using the multiple predicted quantile values for each of the one or more target attributes to set lower and upper bounds for the predicted values for that target attribute;
determining, using the predicted values for each of the one or more target attributes of the final building, one or more buildings that have values for each of the one or more target attributes matching the predicted values for that target attribute; and
providing information to the target first user that includes indications of the determined one or more buildings.

15. The system of claim 14 wherein the received request is a request for dwellings available to be occupied that satisfy one or more specified criteria.

16. The system of claim 15 wherein the request indicates a type of dwelling that is one of a house or a home or an apartment or a condominium, wherein the determined one or more buildings are each of the indicated type of dwelling, and wherein the providing of the information includes presenting the information in a displayed graphical user interface.

17. The system of claim 14 wherein obtaining of the predicted values for each of the one or more target attributes of the final building includes obtaining, for each of the one or more target attributes of the final building, a predicted range of values between the lower and upper bounds for that target attribute, and wherein the determining of the one or more buildings that have values for each of the one or more target attributes includes determining multiple buildings that have values for each of the one or more target attributes in the predicted range for that target attribute.

18. The system of claim 14 wherein the generating of the trained quantile random forest model further includes generating at least one additional model, the at least one additional model including at least one of a gradient boosting model, or a clustering model, or a neural network model, or a linear regression model, and wherein the determining of the one or more buildings further includes using the generated at least one additional model.

19. The system of claim 14 wherein the request for information is a request for overview information of multiple types about buildings, wherein the determining of the one or more buildings includes determining a collection of multiple buildings having values for each of the one or more target attributes matching at least one of the predicted values for that target attribute, and wherein the providing of the information includes generating a page of information that includes an indication of the determined collection of multiple buildings and further includes additional information of one or more types.

20. The system of claim 14 wherein the request for information is a partial request that includes one or more terms, wherein the stored instructions include software instructions that, when executed by the one or more hardware processors, cause the one or more computing devices to perform further automated operations including, before completion of the partial request by the target first user and before the determining of the one or more buildings:
providing one or more suggestions to the target first user for completing the partial request that are based on at least one of the predicted values for each of the one or more target attributes; and
receiving a completed request from the target first user that uses at least one of the provided one or more suggestions,
and wherein the determining of the one or more buildings is performed in response to the receiving of the completed request.

21. The system of claim 14 wherein the request for information is a search request that specifies one or more search criteria, wherein the determining of the one or more buildings further includes determining multiple buildings that satisfy the one or more search criteria, and using the predicted values for each of the one or more target attributes to at least one of filter or rank the determined multiple buildings, and wherein the providing of the information includes providing search results using the at least one of the filtered or ranked determined multiple buildings.

22. A non-transitory computer-readable medium having stored contents that cause one or more computing devices to perform automated operations, the automated operations including at least:
generating, by the one or more computing devices, a trained quantile random forest model that models, for one or more target attributes of one or more buildings that one or more first users will later select to occupy before the one or more first users have selected those one or more buildings, a distribution of values for the one or more target attributes across a plurality of leaf nodes of a plurality of decision trees of the quantile random forest model, wherein generating of the trained quantile random forest model includes using training data about interactions of a plurality of other second users with a plurality of buildings and about a plurality of values of multiple attributes for the plurality of buildings and about a final value for each of one or more target attributes of particular buildings that the plurality of second users later select to occupy;
using, by the one or more computing devices, the trained quantile random forest model to predict, for a target first user separate from the plurality of second users and before the target first user has selected a final building to occupy, values for each of the one or more target attributes of the final building that the target first user will later select, including:
receiving, by the one or more computing devices and from the target first user, one or more specified criteria about buildings;
obtaining, by the one or more computing devices, information about multiple values of the multiple attributes for a group of buildings with which the target first user is associated; and
supplying, by the one or more computing devices, the multiple values of the multiple attributes for the group of buildings as input to the trained quantile random forest model to obtain the predicted values for each of the one or more target attributes of the final building, including obtaining multiple predicted quantile values for each of the one or more target attributes, and using the multiple predicted quantile values for each of the one or more target attributes to set lower and upper bounds for the predicted values for that target attribute; and
providing, by the one or more computing devices, information to the target first user based on the predicted values for at least one of the one or more target attributes of the final building.

23. The non-transitory computer-readable medium of claim 22 wherein the received one or more specified criteria are for dwellings available to be occupied that satisfy the one or more specified criteria.

24. The non-transitory computer-readable medium of claim 23 wherein the one or more specified criteria indicate a type of dwelling that is one of a house or a home or an apartment or a condominium, wherein the group of buildings with which the target first user is associated includes buildings with which the target first user has previously interacted, and wherein the providing of the information includes presenting the information in a displayed graphical user interface.

25. The non-transitory computer-readable medium of claim 23 wherein obtaining of the predicted values for each of the one or more target attributes of the final building includes obtaining, for each of the one or more target attributes of the final building, a predicted range of values between the lower and upper bounds for that target attribute, and wherein the providing of the information to the target first user includes providing information based on the predicted range of values for at least one target attribute.

26. The non-transitory computer-readable medium of claim 22 wherein the one or more specified criteria are part of a request for overview information of multiple types about buildings, wherein the stored contents include software instructions that, when executed by the one or more computing devices, cause the one or more computing devices to perform further automated operations including determining a collection of multiple buildings having values for each of the one or more target attributes matching at least one of the predicted values for that target attribute, and wherein the providing of the information includes generating a page of information that includes an indication of the determined collection of multiple buildings and further includes additional information of one or more types.

27. The non-transitory computer-readable medium of claim 22 wherein the one or more specified criteria are part of a partial request for information, wherein the automated operations further include, before completion of the partial request by the target first user and before the providing of the information:
providing one or more suggestions to the target first user for completing the partial request that are based on the predicted values for each of the one or more target attributes;
receiving a completed request from the target first user that uses at least one of the provided one or more suggestions; and
determining one or more buildings that have values for each of the one or more target attributes matching at least one of the predicted values for that target attribute,
and wherein the providing of the information includes providing information about the determined one or more buildings.

28. The non-transitory computer-readable medium of claim 22 wherein the one or more specified criteria are part of a search request, wherein the automated operations further include determining multiple buildings that satisfy the one or more search criteria, and using the predicted values for each of the one or more target attributes to at least one of filter or rank the determined multiple buildings, and wherein the providing of the information includes providing search results using the at least one of the filtered or ranked determined multiple buildings.

29. The non-transitory computer-readable medium of claim 22 wherein the automated operations further include determining multiple collections each having multiple dwellings with values for one of the one or more target attributes matching at least one of the predicted values for that target attribute, and wherein the providing of the information includes providing indications for display of each of the determined multiple collections.
